(19) United States
(12) Patent Application Publication
(10) Pub. No.: US 2023/0318270 A1
(43) Pub. Date: Oct. 5, 2023

(54) A Fish Tape Assembly

(71) Applicant: INUITIVE LTD., Ra'anana (IL)

(72) Inventor: Eran DOSH, Tel-Mond (IL)

(21) Appl. No.: 17/706,991

(22) Filed: Mar. 29, 2022

(51) Int. Cl. H02G 1/08; G01B 11/02

(52) U.S. Cl. CPC H02G 1/083; G01B 11/028

(57) ABSTRACT

A fish tape assembly comprising: a fish tape having a first and second opposite ends, configured to be pushed/pulled via a conduit pathway extending within a wall; a location indicator coupled to the fish tape, and configured to enable detecting a current location of the location indicator along a conduit pathway, through which the first end of the fish tape is being pushed; and a monitor, configured to enable receiving information that relates to the current location of the location indicator, thereby allowing generation of a three-dimensional (3D) map of the conduit pathway.

### TECHNICAL FIELD

The present disclosure relates to the field of electrical/communication wire installations, and in particular to a fish tape assembly for use in electrical/communication wire installations.

### BACKGROUND

In almost most houses/apartments/office buildings, there is a large number of cavities or conduits (e.g., pipes) that are routed through walls and/or the ceiling and/or the floor. These pipes are used to route electrical/communication wires between two access points, each located at a different location in the house.

One of the problems which typically arises while using such an arrangement is that when there is a need to route a wire via a conduit leading to certain access point, although it is clear which conduit (s) extends from that access point, yet it is typically unknown which second access point is associated with the other end of the conduit, nor the conduit pathway via which that conduit extends between these two access points. This problem might be further intensified in a case where the second, i.e., the unknown access point, is not exposed, hence cannot be detected by a simple visual detection, nor where the electrical box/junction box housing the leading end of the fish tape is located. Furthermore, the electrical box/junction box may be hidden in the wall thus making it to find the electrical box/junction box where the end of the fish tape is located.

The common acceptable prior art solution for the above problems is the use of a fish tape, also known as a draw wire or an electrician snake. This device is typically made of a narrow band of spring steel, which is rigid enough to be guided through confined wall cavities or conduits, yet flexible enough to bend around corners or curves in the conduit. The goal is to push the fish tape through the cavity, and attach a wire or a cable to one of its ends. Once the fish tape end (the one without the attached cable/wire) has reached the second access point, it is pulled through the along the conduit pathway, thereby pulling the wire or cable attached thereto, drawing the wire so that it fills the cavity from one access point to the other.

U.S. Pat. No. 6,293,519 discloses an electrician snake apparatus used to feed electrical wires through spaces contained within existing structures. The apparatus comprising: a thin, flexible, flattened core strip capable of being flattened upon itself having two ends, an attachment end and a manipulator end and a length substantially longer than its cross-sectional width; a phosphorescent coating applied to the core strip at a thickness sufficient to form an electrically non-conducive barrier effectively insulating the metal strip, and capable of providing sufficient luminescence to enable the coated strip to be visible without the benefit of ambient light.

U.S. Ser. No. 10/473,277 describes A lighted wire fishing device for installing wires, that includes a rod that is resilient. The rod is semiflexible so that the rod is configured to be used to fish a wire through a structural element of a structure. A plurality of bulbs is coupled to the rod and extends from proximate to the first end to proximate to a second end of the rod. The plurality of bulbs is operationally coupled to a power module which selectively powers the bulbs to illuminate an area proximate to the rod so that the rod and the wire are visible to a user.

US 20130155668 describes electrician snakes or fishing systems having an electrical power source disposed within the device and a selectively activated light source, which may take the form of an LED.

The present invention seeks to provide a solution that enables mapping of a pathway within walls through which a wire/cable is to be installed, a solution which is not provided by prior art systems.

### SUMMARY OF THE DISCLOSURE

The disclosure may be summarized by referring to the appended claims.

In accordance with one embodiment of the present invention, it is an object of the present invention to provide an improved fish tap assembly.

It is still another object of the present invention to provide an improved fish tape assembly that would allow a person using this assembly to obtain a 3D representation of a conduit pathway (e.g., a pipe), through which a wire/cable is to be installed.

It is another object of the present invention to provide an improved fish tape assembly that would allow a person using the assembly to easily locate the end of the fish tape through its movement along a conduit pathway (e.g., a pipe housing an electrical/communication wire/cable).

Other objects of the present invention will become apparent from the following description.

According to a first embodiment of the present disclosure, there is provided a fish tape assembly comprising:
a fish tape having a first and second opposite ends, configured to be pushed/pulled via a conduit pathway extending within a wall and/or a floor and/or a ceiling;
a location indicator coupled to the fish tape, and configured to enable detecting a current location of the location indicator, along a conduit pathway through which the first end of the fish tape is being pushed; and
a monitor, configured to enable receiving information that relates to the current location of the location indicator, thereby allowing generation of a three-dimensional (3D) map of the conduit pathway.

Optionally, the fish tape assembly further comprises a housing for storing the fish tape.

The term “monitor” as used herein throughout the specification and claims is used to denote any device that is capable of obtaining location related information that relates to the current location of the first end of the fish tape, for generating a three-dimensional (3D) map of the conduit pathway along which the fish tape is moving. Typically, the monitor is a device which is located outside the media through which the conduit pathway is located (e.g., near the wall) and comprises receiving means to enable receipt of the information such as for example Bluetooth/Wi-Fi receiver, thermal camera, communication wire associated with the fish tape (e.g., contained within the fish tape) and the like. However, it should be noted that this term is used also to encompass a device which is located inside the media through which the conduit pathway is located, e.g., a storage associated with the location indicator, that is configured to store information that relates to the current location of the first end of the fish tape, and upon emerging from the media, the storage is further configured to enable retrieving the stored information by an external device (e.g., a smartphone, a computer terminal etc.) for generating a three-dimensional (3D) map of the conduit pathway along which the fish tape is moving.

The term “image sensor” (or “imaging sensor”) as used herein throughout the specification and claims, is used to denote a sensor that detects and conveys information that constitutes an image. This may be achieved by converting the variable attenuation of waves (as they pass through or reflected off objects) into signals.

In accordance with an embodiment of the invention the location indicator is coupled substantially at the first end of the fish tape, and configured to enable detecting the current location of the first end of the fish tape along the conduit pathway, through which the first end of the fish tape is being pushed.

By yet another embodiment, the location indicator may be coupled to the fish tape at any desired location along the fish tape (i.e., at any desired distance from the first end of the fish tape).

According to still another embodiment, the fish tape assembly comprises a plurality of location indicators, each coupled to the fish tape at a different distance from its first end. Optionally, at least one location indicator comprises the same sensor as at least one of the other location indicators, or alternatively, each of the plurality of the location indicators comprises a different sensor from the sensor(s) comprised in the other location indicators.

According to another embodiment of the present disclosure, the location indicator comprises at least one image sensor and a transmitter configured to forward data obtained by the at least one image sensor along the conduit pathway, towards the monitor.

By yet another embodiment of the disclosure, the location indicator comprises inertial sensors and a transmitter configured to forward data obtained by the inertial sensors along the conduit pathway, towards the monitor.

In accordance with another embodiment of the disclosure, the location indicator comprises a combination of at least one image sensor and inertial sensors, and further comprises a transmitter configured to forward data obtained by said combination of sensors along the conduit pathway, towards the monitor.

According to still another embodiment, the location indicator comprises a heat generator configured to generate a hot spot at the first end of the fish tape, and wherein said monitor comprises a thermal detecting means (e.g., a thermal camera) configured to the detect changes in the location of the of the hot spot along the conduit pathway.

According to another embodiment, the location indicator further comprises a power supply.

By yet another embodiment of the present disclosure, the monitor further comprises one or more processors adapted to receive information generated at the first end of the fish tape concerning its current location and to generate a 3D map which describes the conduit pathway that extends between a starting access point at which the first end of the fish tape assembly was inserted into the conduit, to an end access point at which the first end of the fish tape assembly emerged from the wall/ceiling/floor.

### BRIEF DESCRIPTION OF THE DRAWINGS

For a more complete understanding of the present invention, reference is now made to the following detailed description taken in conjunction with the accompanying drawings wherein:

FIG. 1—is an illustration of an example of a fish tape assembly construed in accordance with an embodiment of the present invention;

FIG. 2—is a schematic block diagram exemplifying an embodiment of the present invention of components comprised in the location indicator of the fish tape assembly of FIG. 1; and

FIG. 3—is a schematic block diagram exemplifying an embodiment of the present invention of components comprised in the monitor of the fish tape assembly of FIG. 1.

### DETAILED DESCRIPTION

In this disclosure, the term “comprising” is intended to have an open-ended meaning so that when a first element is stated as comprising a second element, the first element may also include one or more other elements that are not necessarily identified or described herein, or recited in the claims.

In the following description, for the purposes of explanation, numerous specific details are set forth in order to provide a better understanding of the present invention by way of examples. It should be apparent, however, that the present invention may be practiced without these specific details.

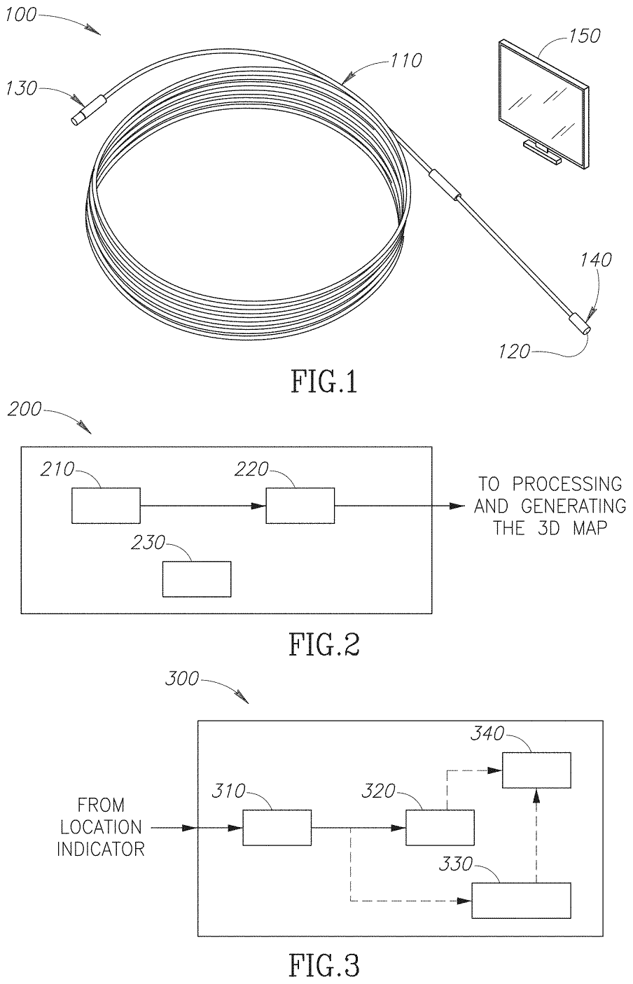

FIG. 1 illustrates an example of a fish tape assembly (100) construed in accordance with an embodiment of the present invention. The fish tape assembly in this example comprises a fish tape (110) having a first (120) and second (130) opposite ends, configured to be pushed/pulled via a conduit pathway extending within a wall and/or a floor and/or a ceiling and a location indicator (140) coupled to a first end (120) of the fish tape (110), configured to enable detecting a current location of the first end of the fish tape along a conduit pathway, through which said first end of the fish tape is being pushed. The fish tape assembly (100) of this example further comprises a monitor (150). Monitor (150) is configured to enable receiving information generated by the location indicator (140), information that relates to the current location of the first end (120) of the fish tape (110), thereby allowing generation of a three-dimensional (3D) map of said conduit pathway.

Although in the example illustrated in FIG. 1 the location indicator is illustrated as being a single location indicator coupled to the first end of the fish tape, the present invention should be understood to encompass other configurations as well. For example, according to the present invention the location indicator may be coupled at any desired location along the fish tape (i.e., at any desired distance from the first end of the fish tape). Moreover, there may a plurality of location indicators, each coupled to the fish tape at a different distance from its first end.

In this example, monitor (150) is an external device such as a smartphone, a computer terminal, and the like that includes one or more processors that receive the information generated by location indicator (140) and generate a three-dimensional (3D) map of the conduit pathway along which the fish tape is moving.

FIG. 2 is a schematic block diagram exemplifying an embodiment of the present invention of components comprised in location indicator (200). First, the location indicator comprises one or more sensors (210) configured to indicate where location indicator (200) is currently present. Such sensors may be an image sensor, an inertial sensor, or any combination thereof.

The signals obtained from the sensor (or the plurality of sensors) are conveyed to a transmitting circuit (220) which is adapted to forward the conveyed signals to one or more processors (not shown in this figure) for their processing in order to generate a three-dimensional map therefrom.

Another optional sensor that may be used in accordance with another embodiment construed in accordance with the present invention is a heat generating sensor (hot spot) which is not shown in this figure. The main operational difference between using this sensor and those described above is that while the output signals retrieved from an image sensor or from inertial sensors is conveyed to a transmitting circuit which in turn forward to processing means, the output of the heat generating sensor is depicted by an external device (such as a thermal module) which is not part of the location indicator.

Location indicator (200) further comprises a power supply circuit (230) which enables the operation of the sensors and the transmitting circuit throughout the movement of the fish tape along the conduit pathway.

FIG. 3 is a schematic block diagram exemplifying an embodiment of the present invention of components comprised in monitor (300). Monitor (300) comprises a receiving circuit (310) that is configured to receive the output generated by the sensor(s) comprised in the location indicator. The receiving circuit forwards the received output in a form of signals to one or more processors (320) which in turn convert the signals into a 3D map of the conduit pathway, through which the fish tape with the location indicator couple thereto are moving. The processed information (or the raw information) received from processor 320 may optionally be stored at storage 330. Also, the processed information may optionally be forwarded from processors 320 to display 340 and displayed thereat as a 3d map of the conduit pathway. In the alternative, the processed information stored at storage 330 may be used to display the 3D map at display 340.

As will be appreciated by those skilled in the art, the map generated by using the fish tape assembly of the present invention, is a three-dimensional map, it includes among others also details about bends in the conduit, blockages/partial blockages in the conduit, and the like, so that any problem which might occur while inserting the fish tape due to bends/blockages of the conduit, can be easily solved by knowing the exact location of the obstacle that is responsible for the problem.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention in any way. The described embodiments comprise different features, not all of which are required in all embodiments of the invention. Some embodiments of the present invention utilize only some of the features or possible combinations of the features.

Variations of embodiments described herein and embodiments of the present invention comprising different combinations of features noted in the described embodiments will occur to persons of the art. The scope of the invention is limited only by the following claims.

1. A fish tape assembly comprising:
a fish tape having a first and second opposite ends, configured to be pushed/pulled via a conduit pathway extending within a wall and/or a floor and/or a ceiling;
a location indicator coupled to the fish tape, configured to enable detecting a current location of the location indicator along a conduit pathway, through which said first end of the fish tape is being pushed; and
a monitor, configured to enable receiving information that relates to the current location of the location indicator, thereby allowing generation of a three-dimensional (3D) map of said conduit pathway.

2. The fish tape assembly of claim 1, wherein the location indicator comprises at least one image sensor and a transmitter configured to forward data obtained by the at least one image sensor along the conduit pathway, towards said monitor.

3. The fish tape assembly of claim 1, wherein the location indicator comprises inertial sensors and a transmitter configured to forward data obtained by the inertial sensors along the conduit pathway, towards said monitor.

4. The fish tape assembly of claim 1, wherein the location indicator comprises a combination of at least one image sensor and inertial sensors, and further comprises a transmitter configured to forward data obtained by said combination of sensors along the conduit pathway, towards the monitor.

5. The fish tape assembly of claim 1, wherein the location indicator comprises a heat generator configured to generate a hot spot at the first end of the fish tape, and wherein said monitor comprises a thermal detecting means configured to the detect changes in the location of the of the hot spot along the conduit pathway.

6. The fish tape assembly of claim 1, wherein said location indicator is coupled substantially at the first end of the fish tape, and configured to enable detecting the current location of the first end of the fish tape along the conduit pathway.

7. The fish tape assembly of claim 1, wherein said location indicator is coupled to the fish tape at any desired location along the fish tape.

8. The fish tape assembly of claim 1, comprising a plurality of location indicators, each coupled to the fish tape at a different distance from its first end.

9. The fish tape assembly of claim 1, wherein the location indicator further comprises a power supply.

10. The fish tape assembly of claim 1, wherein the monitor further comprises one or more processors adapted to receive information generated at the first end of the fish tape concerning its current location and to generate a 3D map which describes the conduit pathway that extends between a starting access point at which the first end of the fish tape assembly was inserted into the conduit, to an end access point at which the first end of the fish tape assembly emerged from the wall/ceiling/floor.
